(19) United States
(12) Patent Application Publication
(10) Pub. No.: US 2019/0048703 A1
(43) Pub. Date: Feb. 14, 2019

(54) REAL-TIME OPTIMIZATION AND VISUALIZATION OF PARAMETERS FOR DRILLING OPERATIONS

(71) Applicant: Landmark Graphics Corporation, Houston, TX (US)

(72) Inventors: Robello Samuel, Cypress, TX (US); Umesh N. Reddy, Houston, TX (US); Aniket Aniket, Houston, TX (US); Zhengchun M. Liu, Sugar Land, TX (US); Gustavo A. Urdaneta, Houston, TX (US)

(21) Appl. No.: 16/081,388

(22) PCT Filed: Apr. 15, 2016
(86) PCT No.: PCT/US2016/027911

§ 371 Date: Aug. 30, 2018

(51) Int. Cl. E21B 44/00; E21B 7/04

(52) U.S. Cl. CPC E21B 44/005; G06F 19/00; E21B 7/043

(57) ABSTRACT

System and methods for optimizing parameters for drilling operations are provided. A target value of a user-selected operating variable is estimated for each stage of a drilling operation to be performed along a planned well path, based on a first set of wellsite data. Values of one or more drilling parameters are determined for performing each stage of the operation, based on the estimated target value of the operating variable for that stage. The target value of the operating variable is updated based on a second set of wellsite data obtained during a current stage of the operation. The values of the drilling parameters are optimized for subsequent stages of the drilling operation based on the updated target value. The planned path of the well is adjusted for the subsequent stages, based on the optimized drilling parameter values. The subsequent stages are performed along the adjusted path of the well.

### FIELD OF THE DISCLOSURE

The present disclosure relates generally to the design and analysis of drilling operations and particularly, to data analysis and visualization tools for optimizing the design and analysis of drilling operations.

### BACKGROUND

To obtain hydrocarbons, such as oil and gas, a borehole is drilled into a hydrocarbon bearing rock formation by rotating a drill bit attached to a drill string. The in drill bit is mounted on the lower end of the drill string as part of a bottom hole assembly (BHA) and is rotated by rotating the drill string at the surface, by actuation of a downhole motor, or both. With weight applied by the drill string, the rotating drill bit engages the formation and forms a borehole toward a target zone.

A number of sensors or measurement devices may be placed in close proximity to the drill bit to measure downhole operating parameters associated with the drilling and downhole conditions. Examples of such downhole parameters may include, but are not limited to, downhole temperature and pressure, azimuth and inclination of the borehole, and formation parameter-measuring devices. Such information may be provided to, for example, a drilling operator at the surface of the borehole for purposes of implementing and monitoring a well plan over different stages of a drilling operation.

When making decisions for effectively planning and implementing a well plan, the drilling operator may need to consider many parameters, some of which may be interrelated. Interactive well planning and monitoring tools are available to aid the operator in the analysis and visualization of multiple parameters simultaneously. Such tools allow the operator to better monitor operating parameters over varying depths and make appropriate adjustments in order to optimize the well plan.

Conventional optimization techniques generally are performed with operating parameters values held constant over different depths. However, the operating parameters for the drilling operation typically also include parameters that are known to vary with depth. Thus, the optimization of a well plan involving such alterable parameters can no longer remain static and instead, must be performed as a function of depth. This may require having to constantly vary constraints and optimized operating parameters to maximize the rate of penetration or minimize specific energy or well cost. However, the ability to consider and alter a large number of parameters over varying depths in an efficient manner can prove difficult for a drilling operator, particularly where the interrelationship between different parameters is unknown or not evident from the downhole information being monitored.

### BRIEF DESCRIPTION OF THE DRAWINGS

FIG. 1 is a diagram showing an example of an offshore drilling system in accordance with one or more embodiments of the present disclosure.

FIG. 2 is a diagram showing an example of an onshore drilling system in accordance with one or more embodiments of the present disclosure.

FIG. 3 is a block diagram of a system for optimizing parameters for different stages of a drilling operation.

FIG. 4 is a flowchart of an illustrative process of optimizing parameters for different stages of a drilling operation.

FIG. 5 is a diagram of an illustrative visualization of actual and estimated target values of an operating variable selected for optimizing a drilling operation along a planned well path.

FIG. 6 is a diagram of an illustrative plot graph including actual and target values of a downhole parameter at different points along a planned well path.

FIG. 7 is a diagram of an illustrative plot graph showing rate of penetration (ROP) parameter values relative to weight on bit (WOB) for different stages of a drilling operation.

FIG. 8 is a diagram of an illustrative plot graph showing ROP parameter values relative to flow rate for different stages of a drilling operation.

FIG. 9 is a block diagram of an illustrative computer system in which one or more embodiments may be implemented.

### DESCRIPTION OF ILLUSTRATIVE EMBODIMENTS

Embodiments of the present disclosure relate to real-time analysis, optimization, and visualization of operating parameters for drilling operations. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

The terms “drilling parameter,” “controllable parameter,” and “parameter” are used interchangeably herein to refer to controllable aspects of a drilling operation that may be altered over the course of the operation and whose values may have an impact on the outcome of the operation. The drilling operation may involve drilling a well along a planned path or trajectory through different layers of a subsurface hydrocarbon bearing formation. As the well is drilled through various types of formations during the operation, downhole operating conditions may change over time. In one or more embodiments, a drilling operator or automated control system may continually adjust one or more drilling parameters in order to increase or maintain drilling efficiency during the operation. Examples of such parameters comprise weight-on-bit (WOB), drilling fluid flow through the drill pipe (flow rate and pressure), rotational speed of the drill string (e.g., rotational rate applied by the top drive unit), the density and viscosity of the drilling fluid, and bottom-hole-assembly (BHA) tool responses (tilt angle and tool face response).

As will be described in further detail below, embodiments may be used to perform real-time data analysis and optimization of one or more drilling parameters associated with different stages of the drilling operation. In one or more embodiments, the drilling parameters may be used to control values of an operating variable over different stages of the operation along a planned path of the well. The operating variable may be selected by a user (e.g., the drilling operator) in order to, for example, monitor a particular aspect of the ongoing drilling operation and optimize one or more drilling parameters used to perform the operation over each stage along the planned well path. Examples of such an operating variable include, but are not limited to, mechanical specific energy, equivalent circulating density (ECD), and rate of penetration (ROP). In one or more embodiments, an initial target value of the selected operating variable may be updated during the drilling operation based on actual conditions in the well measured during a current stage of the operation. The updated target value may then be used to optimize drilling parameters for subsequent stages of the operation along the planned path of the well.

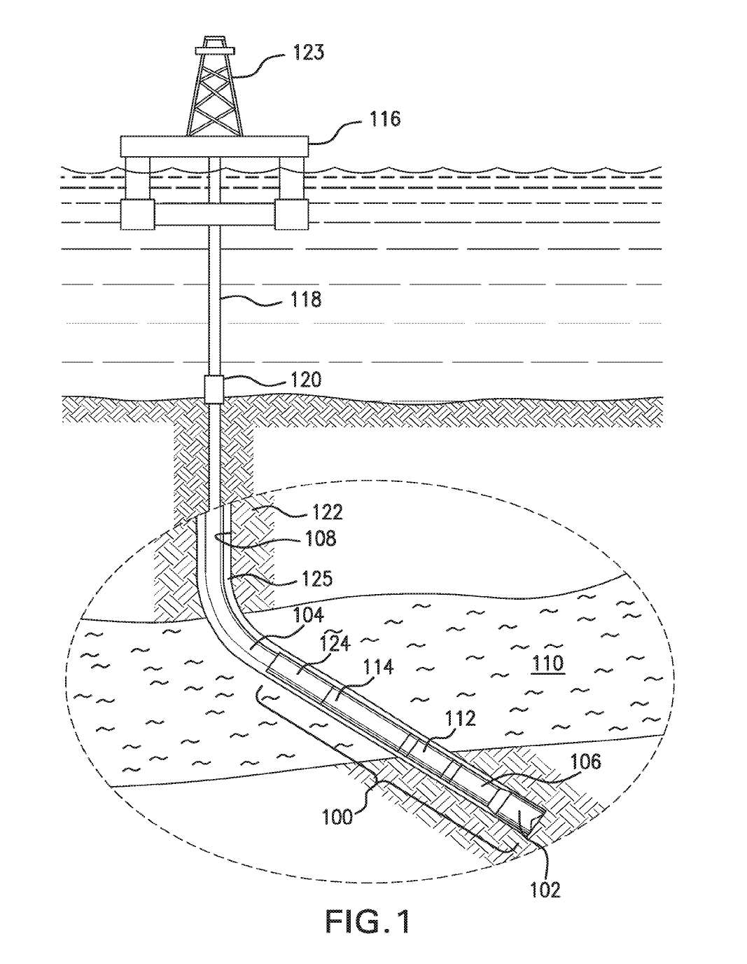

Illustrative embodiments and related methodologies of the present disclosure are described below in reference to FIGS. 1-9 as they might be employed in, for example, a computer system for real-time data analysis and optimization of parameters for drilling operations at one or more wellsites. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented. While the illustrated examples may be described in the context of predicting and controlling a ROP of the drill bit during drilling operations, it should be noted that embodiments are not intended to be limited thereto and that the disclosed data analysis and parameter optimization techniques may also be applied using any of various operating variables as desired for a particular implementation.

FIG. 1 is a diagram showing an example of an offshore drilling system for a subsea drilling operation. In particular, FIG. 1 shows a bottomhole assembly 100 for a subsea drilling operation, where the bottomhole assembly 100 illustratively comprises a drill bit 102 on the distal end of the drill string 104. Various logging-while-drilling (LWD) and measuring-while-drilling (MWD) tools may also be coupled within the bottomhole assembly 100. The distinction between LWD and MWD is sometimes blurred in the industry, but for purposes of this specification and claims LWD tools measure properties of the surrounding formation (e.g., resistivity, porosity, permeability), and MWD tools measure properties associated with the borehole (e.g., inclination, and direction). In the example system, a logging tool 106 may be coupled just above the drill bit, where the logging tool may read data associated with the borehole 108 (e.g., MWD tool), or the logging tool 106 may read data associated with the surrounding formation (e.g., a LWD tool). In some cases, the bottomhole assembly 100 may comprise a mud motor 112. The mud motor 112 may derive energy from drilling fluid flowing within the drill string 104 and, from the energy extracted, the mud motor 112 may rotate the drill bit 102 (and if present the logging tool 106) separate and apart from rotation imparted to the drill string by surface equipment. Additional logging tools may reside above the mud motor 112 in the drill string, such as illustrative logging tool 114.

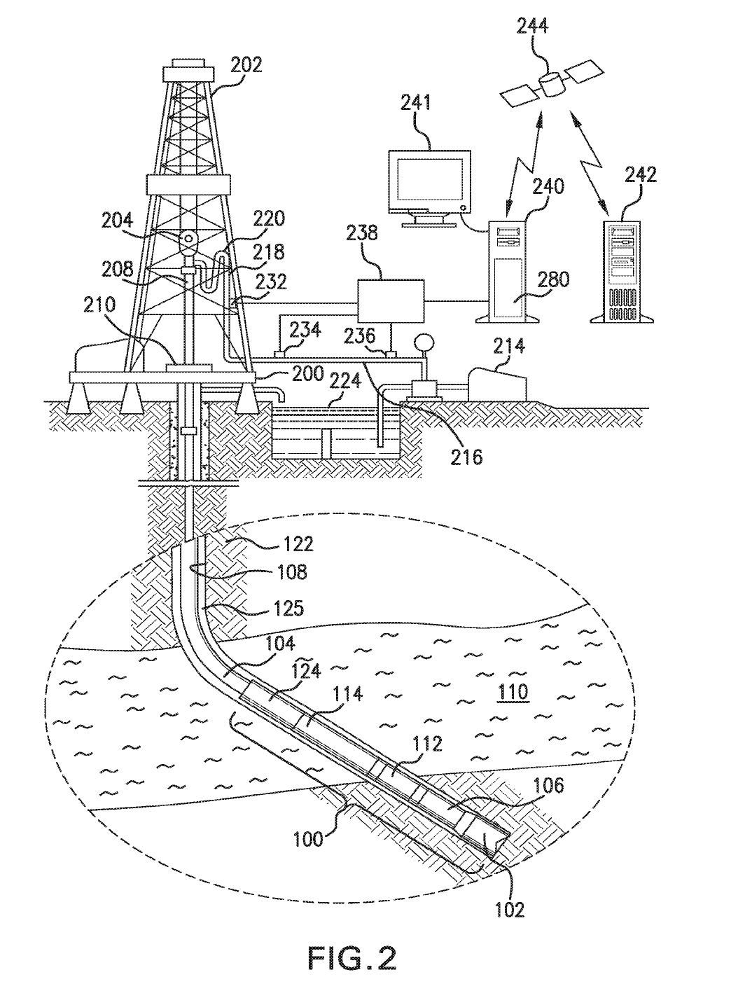

The bottomhole assembly 100 is lowered from a drilling platform 116 by way of the drill string 104. The drill string 104 extends through a riser 118 and a well head 120. Drilling equipment supported within and around derrick 123 (illustrative drilling equipment discussed in greater detail with respect to FIG. 2) may rotate the drill string 104, and the rotational motion of the drill string 104 and/or the rotational motion created by the mud motor 112 causes the bit 102 to form the borehole 108 through the formation material 122. The volume defined between the drill string 104 and the borehole 108 is referred to as the annulus 125. The borehole 108 penetrates subterranean zones or reservoirs, such as reservoir 110, believed to contain hydrocarbons in a commercially viable quantity.

In accordance with one or more embodiments, the bottomhole assembly 100 may further comprise a communication subsystem. In particular, illustrative bottomhole assembly 100 comprises a telemetry module 124. Telemetry module 124 may communicatively couple to the various logging tools 106 and 114 and receive logging data measured and/or recorded by the logging tools 106 and 114. The telemetry module 124 may communicate logging data to the surface using any suitable communication channel (e.g., pressure pulses within the drilling fluid flowing in the drill string 104, acoustic telemetry through the pipes of the drill string 104, electromagnetic telemetry, optical fibers embedded in the drill string 104, or combinations). Likewise, the telemetry module 124 may receive information from the surface over one or more of the communication channels.

FIG. 2 is a diagram showing an example of an onshore drilling system for performing a land-based drilling operation. In particular, FIG. 2 shows a drilling platform 200 equipped with a derrick 202 that supports a hoist 204. The hoist 204 suspends a top drive 208, the hoist 204 and top drive rotate and lower the drill string 104 through the wellhead 210. Drilling fluid is pumped by mud pump 214 through flow line 216, stand pipe 218, goose neck 220, top drive 208, and down through the drill string 104 at high pressures and volumes to emerge through nozzles or jets in the drill bit 102. The drilling fluid then travels back up the wellbore via the annulus 125, through a blowout preventer (not specifically shown), and into a mud pit 224 on the surface. At the surface of the wellsite, the drilling fluid is cleaned and then circulated again by mud pump 214. The drilling fluid is used to cool the drill bit 102, to carry cuttings from the base of the borehole to the surface, and to balance the hydrostatic pressure in the rock formations.

In the illustrative case of the telemetry mode 124 encoding data in pressure pulses that propagate to the surface, one or more transducers, e.g., one or more of transducers 232, 234, and 236, convert the pressure signal into electrical signals for a signal digitizer 238 (e.g., an analog-to-digital converter). While only transducers 232, 234, and 236 are illustrated, any number of transducers may be used as desired for a particular implementation. The digitizer 238 supplies a digital form of the pressure signals to a surface computer system 240 or some other form of a data processing device located at the surface of the wellsite. The surface computer system 240 operates in accordance with computer-executable instructions (which may be stored on a computer-readable storage medium) to monitor and control the drilling operation, as will be described in further detail below. Such instructions may be used, for example, to configure the surface computer system 240 to process and decode the downhole signals received from the telemetry mode 124 via digitizer 238.

In one or more embodiments, data collected at the wellsite, including the downhole logging data from the telemetry module 124, may be displayed on a display device 241 coupled to the computer system 240. The representation of the wellsite data may be displayed using any of various display techniques, as will be described in further detail below. In some implementations, the surface computer system 240 may generate a two-dimensional (2D) or three-dimensional (3D) graphical representation of the wellsite data for display on the display device 241 a graphic. The graphical representation of the wellsite data may be displayed with a representation of the planned well path for enabling a user of the computer system 240 to visually monitor or track different stages of the drilling operation along the planned path of the well.

In one or more embodiments, the representations of the wellsite data and planned well path may be displayed within a graphical user interface (GUI) of a well engineering application 280 executable at the surface computer system 240. Well engineering application 280 may provide, for example, a set of data analysis and visualization tools for well planning and control. Such tools may allow the user to monitor different stages of the drilling operation and adjust the planned well path as needed, e.g., by manually adjusting one or more drilling parameters via the GUI of well engineering application 280 to control the direction and/or orientation of the well path. Alternatively, the monitoring and control of the drilling operation may be performed automatically, without any user intervention, by well engineering application 280.

For example, as each stage of the drilling operation is performed and a corresponding portion of the well is drilled along its planned path, well engineering application 280 may receive indications of downhole operating conditions and values of drilling parameters used to control the drilling of the well during the operation. Examples of such drilling parameters include, but are not limited to, WOB, drilling fluid flow rate and pressure (within the drill pipe), rotational speed of the drill string and/or drill bit (e.g., rotational rate applied by the top drive unit and/or a downhole motor), and the density and viscosity of the drilling fluid. In response to receiving indications of downhole operating conditions during a current stage of the drilling operation, the surface computer system 240 may automatically send control signals to one or more downhole devices (e.g., a downhole geosteering tool) in order to adjust the planned path of the well for subsequent stages of the operation. The control signals may include, for example, optimized values of one or more drilling parameters for performing the subsequent stages of the drilling operation along the adjusted path of the well.

In one or more embodiments, some or all of the calculations and functions associated with the manual or automated monitoring and control of the drilling operation at the wellsite may be performed by a remote computer system 242 located away from the wellsite, e.g., at an operations center of an oilfield services provider. In some implementations, the functions performed by the remote computer system 242 may be based on wellsite data received from the wellsite computer system 240 via a communication network. Such a network may be, for example, a local-area, medium-area, or wide-area network, e.g., the Internet. As illustrated in the example of FIG. 2, the communication between computer system 240 and computer system 242 may be over a satellite 244 link. However, it should be appreciated that embodiments are not limited thereto and that any suitable form of communication may be used as desired for a particular implementation. While not shown in FIG. 2, the remote computer system 242 may execute a similar application as the well engineering application 280 of system 240 for implementing all or a portion of the above-described wellsite monitoring and control functionality. For example, such functionality may be implemented using only the well engineering application 280 executable at system 240 or using only the well engineering application executable at the remote computer system 242 or using a combination of the well engineering applications executable at the respective computer systems 240 and 242 such that all or portion of the wellsite monitoring and control functionality may be spread among the available computer systems.

While the examples in FIGS. 1 and 2 are described in the context of a single well and wellsite, it should be appreciated that the well monitoring and control functionality disclosed herein may be applied to multiple wells at various sites throughout a hydrocarbon producing field. For example, the remote computer system 242 of FIG. 2, as described above, may be communicatively coupled via a communication network to corresponding wellsite computer systems similar to the computer system 240 of FIG. 2, as described above. The remote computer system 242 in this example may be used to continuously monitor and control drilling operations at the various wellsites by sending and receiving control signals and wellsite data to and from the respective wellsite computer systems via the network.

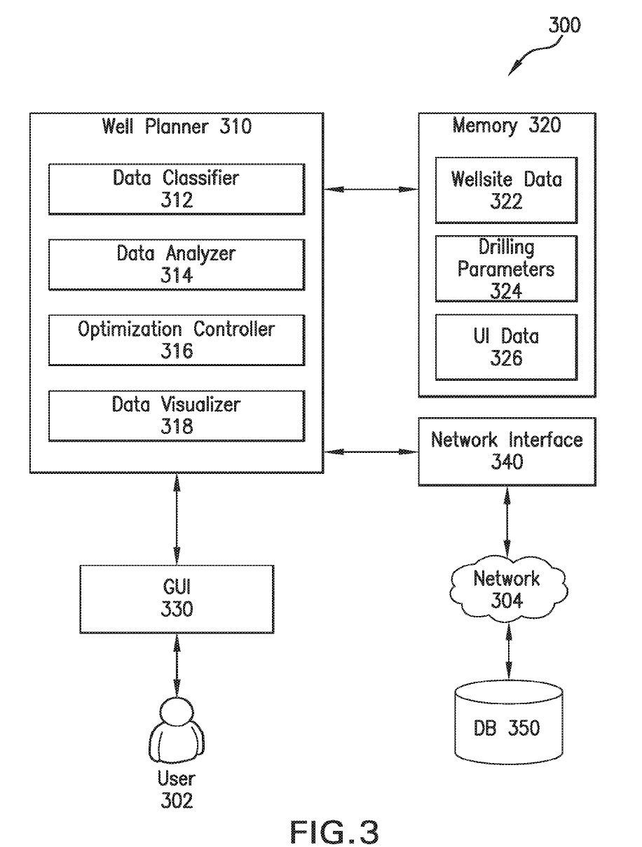

In one or more embodiments, the wellsite monitoring and control functionality provided by computer system 242 (and computer system 240 or well engineering application 280 thereof) may include real-time data analysis and optimization of the drilling operation over different stages of the operation along the planned path of the well. As will be described in further detail below with respect to FIGS. 3-8, such optimization may include optimizing one or more drilling parameters for performing each stage of the drilling operation along a portion of the planned path of the well based on the analysis of wellsite data collected in real-time during that stage of the operation.

FIG. 3 is a block diagram of a system 300 for real-time data analysis and optimization of parameters for different stages of a drilling operation. The drilling operation may be, for example, a subsea drilling operation for drilling a well along a planned path through a subsurface formation at an offshore wellsite, as described above with respect to FIG. 1. Alternatively, the drilling operation may be a land-based drilling operation for drilling the well along a planned path through a subsurface formation at an onshore wellsite, as described above with respect to FIG. 2. As shown in FIG. 3, system 300 includes a well planner 310, a memory 320, a graphical user interface (GUI) 330, and a network interface 340. In one or more embodiments, the well planner 310 includes a data classifier 312, a data analyzer 314, an optimization controller 316, and a data visualizer 318. Although not shown in FIG. 3, it should be appreciated that system 300 may include additional components and sub-components to provide the real-time data analysis and parameter optimization functionality described herein.

The network interface 340 of the system 300 may comprise logic encoded in software, hardware, or combination thereof for communicating with a network 304. For example, the network interface 340 may comprise software supporting one or more communication protocols such that hardware associated with the network interface 340 is operable to communicate signals to other computing systems and devices via the network 304. The network 304 may be used, for example, to facilitate wireless or wireline communications between the system 300 and the other computing systems and devices. In some implementations, the system 300 and the other systems and devices may function as separate components of a distributed computing environment in which the components are communicatively coupled via the network 304. While not shown in FIG. 3, it should be appreciated that such other systems and devices may include other local or remote computers including, for example and without limitation, one or more client systems, servers, or other devices communicatively coupled via the network 304.

The network 304 may be one or any combination of networks including, but not limited to, a local-area, medium-area, or wide-area network, e.g., the Internet. Such network(s) may be all or a portion of an enterprise or secured network. In some instances, a portion of the network 304 may be a virtual private network (VPN) between, for example, system 300 and other computers or other electronic devices. Further, all or a portion of the network 304 can include either a wireline or wireless link. Examples of such wireless links include, but are not limited to, 802.11a/b/g/n, 802.20, WiMax, and/or any other appropriate wireless link. The network 304 may encompass any number of internal (private) or external (public) networks, sub-networks, or combination thereof to facilitate communications between various computing components including the system 300.

In one or more embodiments, the system 300 may use the network 304 to communicate with a database 350. The database 350 may be used to store data accessible to the system 300 for performing the data analysis and parameter optimization functionality described herein. The database 350 may be associated with or located at the operations center of an oilfield services provider, as described above with respect to computer system 242 of FIG. 2. The stored data may include, for example, historical wellsite data and parameters associated with drilling operations at various wellsites, e.g., other wellsites within the same hydrocarbon producing field as the wellsite in this example. Additionally or alternatively, the data may include data collected in real-time from the wellsite during the different stages of the drilling operation. Such real-time data may be retrieved from the database 350 via the network 304 and stored within memory 320 as wellsite data 322. In some implementations, the data may be streamed from the database 350 as a real-time data feed to a designated buffer or storage area corresponding to wellsite data 322 within memory 320.

In one or more embodiments, the wellsite data 322 may include data transmitted via network 304 directly from a surface control system (e.g., surface computer system 240 of FIG. 2, as described above) at a drilling rig or offshore platform using an industrial format such as the wellsite information transfer standard markup language (WITSML). WITSML is known to facilitate the free flow of technical data across networks between oil companies, service companies, drilling contractors, application vendors and regulatory agencies for the drilling, completions, and interventions functions of the upstream oil and natural gas industry. However, it should be appreciated that the wellsite data 322 can be transmitted and stored using any type of data format, standard, or structure as desired for a particular implementation.

The stored wellsite data 322 may include various types of data. Examples of such data types include, but are not limited to, depth (measured and vertical), flow rate, weight on bit, bit rotational speed, bit size, drill collar length, rate of penetration, torque and drag on the string, chloride filtrate, plastic viscosity, yield point, mud weight and gel strength. Other data types may also be included for optimization calculation, such as calcium filtrate, chloride filtrate, torque, circulating pressure, WOR, drag, bit size, bottom-hole assembly, ROP, and rotational speed of the drill bit (e.g., in revolutions per minute (RPM)). In some implementations, the stored wellsite data 322 may also include “right time” data, which may include, for example, pre-determined data for one or more predetermined conditions, such as a data template under certain conditions.

In one or more embodiments, the data classifier 312 of well planner 310 may preprocess and classify the stored wellsite data 322 or data feed received via the network 304 from the database 350 or wellsite control system prior to storage. The preprocessing may include, for example, filtering the data into a predetermined sampling rate. In some implementations, the data classifier 312 may include one or more digital filters, analog filters, or a combination thereof. Examples of such filters include, but are not limited to, a band-pass filter, a Kalman filter, a high pass filter, a low pass filter, an average filter, a noise reduction filter, a delay filter, a summation filter, a format conversion filter, and other types of filters. The preprocessed data may then be classified for use in prediction and optimization of one or more drilling parameters used to calculate values of a selected operating variable for different stages of the drilling operation, as will be described in further detail below.

In one or more embodiments, the data may be classified based on the type of data analysis to be performed by the data analyzer 314 of well planner 310. For example, the data analyzer 314 may be used to perform various types of data analyses related to different aspects of the drilling operation. Examples of such analyses include, but are not limited to, torque and drag analysis, hydraulic analysis, transient swab and surge analysis, well control, drill ahead predication, vibration analysis, casing centralization placement, drill string dynamics, BHA dynamics, kick tolerance, and stuck pipe analysis. In one or more embodiments, each type of data analysis may be associated with an operating variable for monitoring and optimizing each stage of the drilling operation along the planned path of the well. Examples of operating variables that may relate to one or more of the different types of data analyses listed above include, but are not limited to, equivalent circulating density (ECD), circulating pressure, ROP, specific energy, hook load, tension, torque, side force, and sensitivity analysis. In one or more embodiments, the operating variable and well plan may be selected by a user 302 via the GUI 330.

In one or more embodiments, the results of one or any combination of different types of analyses may be used during the drilling operation to predict one or more of ROP, specific energy, drilling efficiency, well profile energy, stuck pipe conditions, excessive vibration, increased buildup of cuttings bed, and friction factor deviation at various points along the planned path of the well. In addition, analysis results may be used to estimate drilling efficiency over different stages of the operation based on the compressive rock strength of the surrounding formation along the planned well path, e.g., based on the associated unconfined rock strength (UCS) and/or confined rock strength (CCS) value of the formation or LWD log data.

Thus, using stuck pipe conditions as an example, the data classifier 312 may classify data within the wellsite data 322 and associated drilling parameters using the following classification categories pertaining to a stuck pipe analysis to be performed by the data analyzer 314: mechanical, differential, and non-stuck. Examples of drilling parameters that may belong to one or more of these categories include, but are not limited to, measured depth, actual vertical depth, flow rate, weight on bit, bit rotational speed, bit size, drill collar length, rate of penetration, torque and drag on the string, chloride filtrate, plastic viscosity, yield point, mud weight and gel strength. It should be appreciated that the parameters in this example may be common to both stuck and non-stuck wells.

In one or more embodiments, the data analysis performed by the data analyzer 314 based on the data and parameters classified by the data classifier 312 may include estimating an initial target value of a selected operating variable for each stage of the drilling operation to be performed along the planned path of the well. The initial target value may then be used by the data analyzer 314 to determine values of one or more drilling parameters for performing each stage of the drilling operation along a corresponding portion of the planned well path. The values of the drilling parameters may be stored as drilling parameters 324 within the memory 320.

In one or more embodiments, the drilling parameter values may be provided to the optimization controller 316 of the well planner 310 for performing one or more stages of the drilling operation at the wellsite. The optimization controller 316 in turn may provide the parameter values as control inputs to a downhole geosteering tool used to drill the well along the planned path through the formation. For example, the optimization controller 316 may be communicatively coupled to the downhole geosteering tool via a wireless or wired (e.g., wireline) communication interface (not shown) of the system 300. Such a communication interface may be used by the optimization controller 316 to transmit the parameter values as control signals to the downhole geosteering tool. The control signals may allow the optimization controller 316 to control, for example, the direction and orientation of the geosteering tool and thereby, adjust the planned path of the well during the drilling operation.

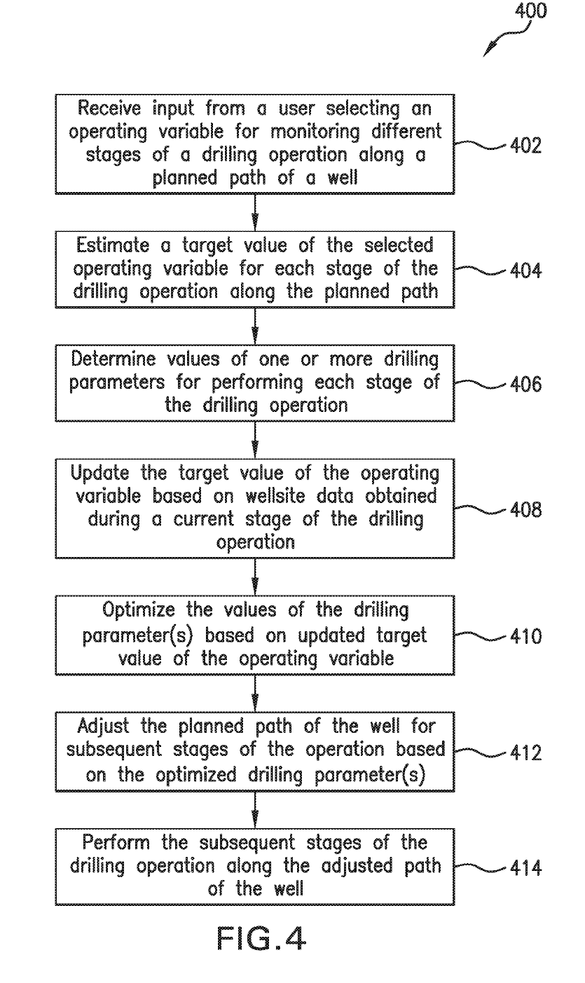

As the operation is implemented along the planned well path, additional wellsite data may be collected by a downhole tool (e.g., downhole tool 106 of FIGS. 1 and 2, as described above). Such data may include, for example and without limitation, formation property measurements and other data related to the downhole operation in progress. As described above, such wellsite data may be obtained either directly or indirectly by system 300 via the network 304. In one or more embodiments, the optimization controller 316 may use such additional data to automatically monitor the drilling operation and perform various optimizations. As will be described in further detail below with respect to FIG. 4, such optimizations may include updating the target value of the operating variable based on the additional wellsite data collected during a current stage of the drilling operation and optimizing the values of one or more drilling parameters for performing subsequent stages of the operation along the planned well path.

In one or more embodiments, a visualization of the values of the operating variable may be provided by the data visualizer 318 of the well planner 310 as part of the results of the data analysis and optimization performed by the data analyzer 314 and the optimization controller 316. The visualization may be presented by the data visualizer 318 to the user 302 via the GUI 330. The GUI 330 may be any type of display device (not shown) coupled to system 300. Such an output device may be, for example and without limitation, a cathode ray tubes (CRT), liquid crystal displays (LCD), or light emitting diode (LED) monitor. The user 302 may interact with the GUI 330 using an input control device (also not shown) coupled to the system 300. The user input device may be, for example and without limitation, a mouse, a QWERTY or T9 keyboard, a touch-screen, a stylus or other pointer device, a graphics tablet, or a microphone. In some implementations, the user 302 may use the information displayed via the GUI 330 to assess drilling performance at each stage of the operation and make any adjustments to the planned path of the well, e.g., by entering appropriate commands into a drilling operation control module used to control the drilling operations at the wellsite.

In one or more embodiments, the information to be displayed or visualized via the GUI 330 may be stored in memory 320 as UI data 326. Such information may include, for example, UI control information specifying the details related to the visual layout and appearance of the graphical representation and any UI control elements to be displayed via the GUI 330. The UI control information may also include domain logic for control and validation of the type of input that the user may enter for a particular operating variable, e.g., via a UI control element displayed within the GUI 330 for enabling the user 302 to select a particular operating variable of interest or update the target value thereof. For example, the user 302 may change the value of the operating variable or one or more associated drilling parameters by using a mouse or other pointer device to manipulate a visual marker representing an estimated target value of the operating variable within the visualization displayed via the GUI 330. Alternatively, the operating variable may be updated automatically by optimization controller 316 without any user intervention.

FIG. 4 is a flowchart of an illustrative process 400 of optimizing parameters for different stages of a drilling operation. The drilling operation may involve drilling a well along a planned path through a subsurface hydrocarbon bearing formation, as described above. For purposes of explanation and discussion, process 400 will be described using system 300 of FIG. 3, as described above. However, process 400 is not intended to be limited thereto. Also, for discussion purposes, process will be described using drilling systems 100 and 200 of FIGS. 1 and 2, respectively, but is not intended to be limited thereto. The operations corresponding to blocks 402, 404, 406, 408, 410, 412, and 414 of process 400 may be performed by, for example, well planner 310 of system 300, as described above.

Process 400 begins at block 402, which includes receiving input from a user (e.g., user 302 via the GUI 330 of FIG. 3, as described above). The input may include the user's selection of an operating variable for analyzing a particular aspect of the drilling operation for purposes of planning and optimizing the well path over different stages of the operation. The selected operating variable may be, for example and without limitation, ROP, a mechanical specific energy, or a cost of the drilling operation. At block 404, an initial target value of the selected operating variable is estimated for each stage of the drilling operation along the planned path of the well. For example, depending on the particular operating variable selected at block 402 above, the target value may be estimated to reduce mechanical specific energy, reduce hydro-mechanical specific energy, or reduce overall cost of drilling the borehole. The initial target value may be estimated based on a first set of wellsite data associated with the planned path of the well. The first set of wellsite data may include, for example, historical wellsite data associated with drilling operations at various wellsites, e.g., other nearby wellsites within the same hydrocarbon producing field as the wellsite in this example. The initial target value may represent, for example, an optimum or ideal value of the operating variable estimated for each stage of the drilling operation. In some implementations, the initial target value may represent a limit for the value of the operating variable (e.g., a maximum limit, minimum limit, deviation limit) for each stage of the drilling operation.

Process 400 then proceeds to block 406, which includes determining values of one or more drilling parameters for performing each stage of the drilling operation along a corresponding portion of the planned well path. In one or more embodiments, the drilling parameters may be part of a set of drilling parameters used to control values of the operating variable selected at block 402. Accordingly, the values determined for the drilling parameters of each stage of the drilling operation may be dependent upon the estimated target value of the operating variable for that stage. The operations in blocks 404 and 406 may be performed by, for example, data analyzer 314 of FIG. 3, as described above.

Thus, for the ROP example described above, the initial target value estimated at block 404 may be an estimated target ROP for each stage of the drilling operation, and the values of determined at block 406 may be target values for drilling parameters that may be used to control the ROP along the planned well path. Examples of such drilling parameters include, but are not limited to, weight-on-bit, fluid flow rate, and rotational speed of the drill bit. The values of ROP may calculated using any various equations including, for example, Equations (1), (2), and (3) as follows:

$$\begin{matrix}ROP = {W}_{f} \cdot G \cdot \frac{{WOB}^{a} \cdot {N}^{b}}{S \cdot {D}_{b}} & ( 1 ) \\ ROP = {{K}_{f} ( \frac{WOB}{4 {D}_{b}} )}^{{a}_{1}} {( \frac{N}{100} )}^{{a}_{2}} & ( 2 ) \\ ROP ( WOB , N ) ⇒ max , ROP = {{K}_{f} ( \frac{WOB}{4 {D}_{b}} )}^{{a}_{1}} {( \frac{N}{100} )}^{{a}_{2}} . & ( 3 )\end{matrix}$$

In the above Equations (1)-(3), W_{f} is the wear function, G is the ROP model constant, WOB is the weight-on-bit, N is the speed of bit rotation (RPM), S is confined rock compressive strength, D_{b} is the drill bit diameter, and K_{f} is the empirical ROP model constant.

At block 408, the target value of the operating variable may be updated based on a second set of wellsite data obtained during a current stage of the drilling operation performed along the planned path of the well. The second set of wellsite data may include, for example, real-time data collected from the wellsite as the operation is performed along the planned well path. As described above, such data may include may include data obtained via a communication network (e.g., network 304 of FIG. 3, as described above) from a surface control system (e.g., surface computer system 240 of FIG. 2, as described above) located at a drilling rig or offshore platform. Also, as described above, such data may include various measurements collected in real-time by a downhole tool (e.g., logging tool 106 of FIGS. 1 and 2, as described above) during the drilling operation. Such measurements may include, but are not limited to, depth (measured and vertical), flow rate, weight on bit, bit rotational speed, bit size, drill collar length, rate of penetration, torque and drag on the string, chloride filtrate, plastic viscosity, yield point, mud weight, gel strength, torque, circulating pressure, WOB, drag, bit size, bottom-hole assembly, and rotational speed (or RPM) of the drill bit.

In one or more embodiments, block 408 may include calculating an actual value of the operating variable at different points along the planned well path, based on the real-time data obtained for those points during the current stage of the drilling operation. Each point may represent, for example, an incremental depth and/or length along the planned well path. The actual value of the operating variable for each point may be compared with the previously estimated target value (from block 404) for that point. The previously estimated target value may then be updated based on the results of the comparison. For example, the target value may be updated if there is a significant variation (e.g., beyond a predetermined tolerance threshold) between the estimated and actual values of the operating variable. In some implementations, the target value may be updated by averaging the estimated and actual values of the operating variable to generate a new target value. However, it should be appreciated that embodiments are not limited thereto and that other techniques may be used to generate the new target value or update the previously estimated value of the operating variable. Accordingly, the updated target value of the operating variable may represent a suggested or optimized value of the operating variable based on actual downhole conditions and practical real-world considerations to be taken into account for optimizing the drilling operation, e.g., for maximizing drilling efficiency and maintaining drilling performance over different stages of the operation.

At block 410, the values of the one or more drilling parameters are optimized based on the updated target value of the operating variable. The drilling parameters may be optimized using any of various techniques including, but not limited to, neural-net based pattern recognition, fuzzy logic, regression analysis using a support vector machine, and Monte Carlo simulation. The operations in blocks 408 and 410 may be performed by, for example, optimization controller 316 of FIG. 3, as described above.

The optimized drilling parameters may then be used for performing subsequent stages of the drilling operation. For example, at block 412, the planned path of the well may be adjusted for subsequent stages of the drilling operation, based on the optimized values of the one or more drilling parameters. At block 414, the subsequent stages of the drilling operation may be performed along the adjusted path of the well.

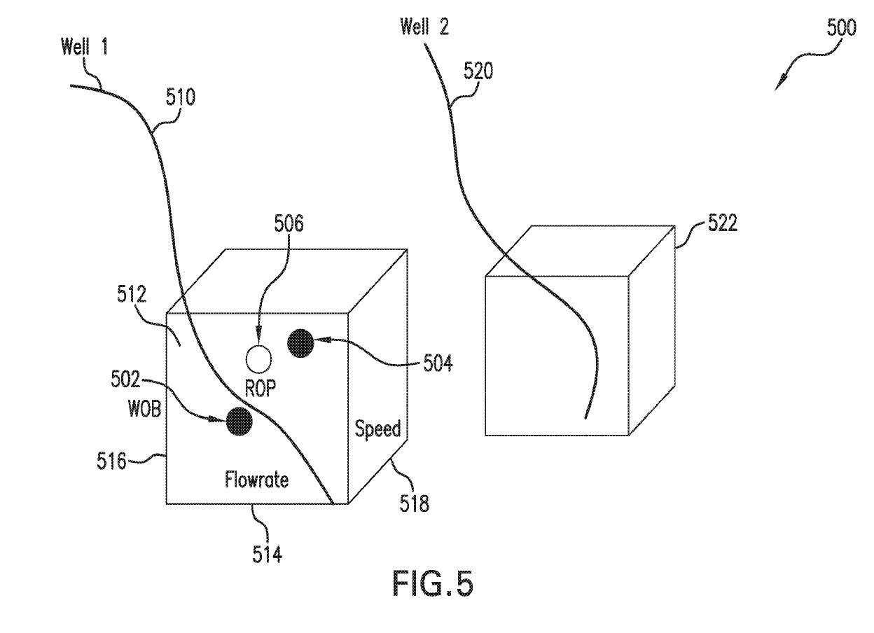

While not shown in FIG. 4, process 400 may also include operations for providing a visualization of the actual and target values of the operating variable along different sections of the planned path of the well. Such operations may be performed by, for example, data visualizer 318 of FIG. 3, as described above. The visualization may include, for example, a two-dimensional (2D) or three-dimensional (3D) graphical representation of the actual, initially estimated, and updated (or suggested) target values of the operating variable along with optimized drilling parameters for various points along the planned path of the well. An example of such a visualization is shown in FIG. 5.

FIG. 5 is a view of an illustrative visualization 500 of actual and estimated target values of an operating variable selected for optimizing a drilling operation along a planned well path. As shown in FIG. 5, the visualization 500 may include a graphical representation of a well path 510. The graphical representation may be, for example, a 3D representation of the well path 510 that can be projected onto a 2D surface of a display device (e.g., display device 241 of FIG. 2, as described above) in such a way as to appear as 3D to a drilling operator. The visualization 500 may include, for example, a representation of portions of the well path 510 that have already been drilled within the formation during one or more previous stages of the drilling operation. Additionally, the visualization 500 may include a representation of a portion of the well path 510 that is currently being drilled during a current stage of the drilling operation. The visualization 500 may further include a representation of the expected future path of the well path 510 that has yet to be drilled during subsequent stages of the drilling operation. In some implementations, the visualization 500 may include one or more log curves representing real-time data collected by a downhole tool as the drilling operation is performed along the well path 510.

In one or more embodiments, the representation of the portion of the well path 510 corresponding to the current stage of the drilling operation may be visualized or displayed within a 3D shape 512 representing boundary conditions or constraints for values of the operating variable during the current stage. As shown in the example of FIG. 5, the 3D shape 512 may be a cube, but embodiments are not intended to be limited thereto. The 3D shape 512 may be any type of 3D shape as desired for a particular implementation. The dimensions or faces of the 3D shape 512 in this example may visually represent the boundary conditions for the operating variable based on values of drilling parameters selected for controlling the value of the operating variable during the current stage of the operation along the well path 510. For example, the selected parameters may be from a larger set of drilling parameters used to calculate the operating variable. However, the values of the selected parameters may have the greatest impact on the calculation and therefore, may be primarily responsible for controlling the resulting value of the operating variable.

The position of each face of the 3D shape 512 as shown in FIG. 5 may correspond to, for example, a predetermined maximum limit on the value of such a drilling parameter as plotted along an axis of a 3D coordinate system. The well path 510 in this example may be considered a spatial path plotted against such a 3D coordinate system. Each axis of the 3D coordinate system may represent a different drilling parameter associated with the operating variable. It should be appreciated that the disclosed embodiments are not intended to be limited to such a coordinate system and that numerous variations and modifications to the illustrative system are possible. For example, the number of dimensions of the coordinate system is not limited to two or three, and thus the coordinate system may be an n-dimensional space. Further, the axes of such a coordinate system need not be orthogonally related.

Using ROP as the operating variable for purposes of the example as shown in FIG. 5, the associated drilling parameters may include drilling fluid flow rate, WOB, and rotational speed of the drill bit. Thus, an x-axis 514 of the coordinate system may represent flow rate, a y-axis 516 may represent WOB, and a z-axis 518 may represent rotary speed of the drill bit. A visual marker 502 representing the current value of the ROP as plotted within the 3D coordinate system may be shown at a location that corresponds to the drilling fluid flow rate, WOB, and rotational speed of the drill bit that produces the current ROP. Similarly, a visual marker 504 representing an initial target value of the ROP as plotted within the 3D coordinate system may be shown at a location corresponding to values of the drilling fluid flow rate, WOB, and rotational speed of the drill bit expected to produce the target value of the ROP during the current stage of the operation. The initial target value may represent, for example, an optimum or ideal target value estimated for the ROP prior to the current stage of the operation (e.g., at block 404 of process 400 of FIG. 4, as described above).

As described above, the initial target value may be estimated based on historical wellsite data associated with one or more nearby wells. In one or more embodiments, the initial target value of the operating variable estimated for the current stage of the operation may be based on the actual value of the operating variable associated with a nearby well that has already been drilled through the same or similar type of formation material as the current well. Thus, as shown in the example of FIG. 5, the visualization 500 may include a representation of a well path 520 associated with a nearby well. The representation may include a 3D shape 522 representing boundary conditions for the operating variable and associated values of drilling parameters, similar to the 3D shape 512 displayed for the well path 510. It may be assumed for purposes of this example that the actual ROP achieved in the nearby well provides a better indication of optimum values of ROP and associated drilling parameters for the current well. Accordingly, the initial target value of the ROP represented by the visual marker 504 along the well path 510 for the current well in this example may be set to an actual value of the ROP calculated at a corresponding point along the length of the well path 520 for the nearby well. Additionally or alternatively, the actual value of the operating variable from the nearby well may later be used to update the initial target value of the operating variable for the current well, as will be described in further detail below.

In the example of FIG. 5, the positions of visual markers 502 and 504 within the 3D coordinate system show a difference between the current and target values of the ROP, respectively. As described above, the initial or previously estimated target value may then be updated (e.g., at block 406 of process 400 of FIG. 4) for the current and subsequent stages of the drilling operation to reflect actual downhole conditions in the well. The target value of the ROP in this example may be updated using any of various techniques to bring the updated target value closer to actual values of the ROP expected along the planned well path. A visual marker 506 representing the updated target value may also be displayed within the 3D coordinate system. Also, as described above, the values of the drilling parameters may be updated or optimized based on the updated target value of the operating variable. Accordingly, the dimensions of the 3D shape 512 and boundary conditions of the operating variable as plotted within the 3D coordinate system may be adjusted based on the updated/optimized values of the drilling parameters.

While the visual markers 502, 504, and 506 for the values of the operating variable are shown as circles or spherical dots in FIG. 5, it should be noted that the disclosed embodiments are not intended to be limited thereto and that any of various visualization techniques may be used to indicate such values as desired for a particular implementation. In some implementations, the size and other visual attributes (e.g., color or opacity) of each visual marker may be adjusted to reflect the magnitude of the value represented by that marker. Further, each visual marker may be displayed with the numerical value or other textual information associated with the operating variable represented by that marker.

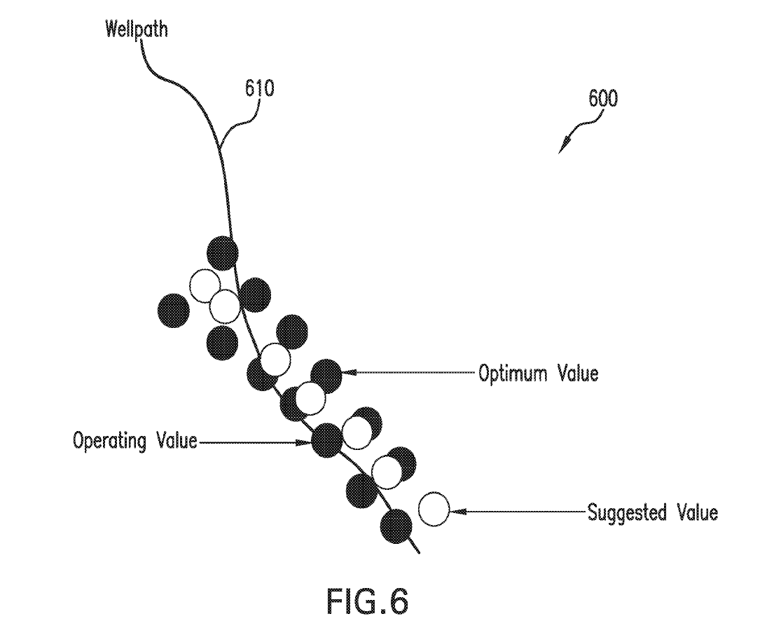

Also, while only visual markers 502, 504, and 506 are shown for a single set of values of the operating variable at a particular point (e.g., a current depth) along the well path 510 in FIG. 5, it should be appreciated that embodiments are not limited thereto. For example, as shown in FIG. 6, the visualization may include visual markers for different sets of values of the operating variable calculated for different points along the planned well path. In FIG. 6, a visualization 600 includes different sets of visual markers similar to markers 502, 504, and 506 of FIG. 5 for indicating the actual value, the initial target value, and the updated target value of an operating variable (e.g., ROP), respectively, for each of a series of points along a planned well path 610. The visualization 600 may be useful in providing feedback to a user, e.g., a drilling operator, as to how well previous changes to drilling parameters have affected the operating variable over the course of the drilling operation.

In one or more embodiments, the length of the well path 510 and 610 as represented in the visualizations 500 and 600 of FIGS. 5 and 6, respectively, may be adjusted as the actual drilled depth or length of the well within the formation increases. In some implementations, the 3D coordinate system may be shifted or repositioned to a new location relative to the respective well paths as the drilling progresses along the well path. Alternatively, the displayed representation of the well path may be shifted while keeping the coordinate system at a fixed location. In some cases, previously plotted portions of each well path remain at stationary locations and the coordinate system moves to the new distal end of the well path. In other cases, the visual markers representing the plotted actual and target values of the operating variable may be updated based on re-plotted values for each new location of the coordinate system relative to the well path. However, in yet other cases, visual markers displayed for previously plotted values of the operating variable may be left in place (or moved to corresponding positions within a new location of the coordinate system relative to the well path) such that the change in these values over time may be observed by the drilling operator. Further, the previously plotted actual and target values may be animated in a repeating loop to show the progression over time. The displayed animation may include a 3D representation of the optimized drilling parameters that may be displayed as the well is drilled in real time. The 3D representation may be in the form of a 3D cube or other 3D shape, as described above. The displayed 3D representation may support user interaction enabling, for example, the drilling operator to “play back” the drilling situation starting from any previous depth or time to any target depth or time, including the present.

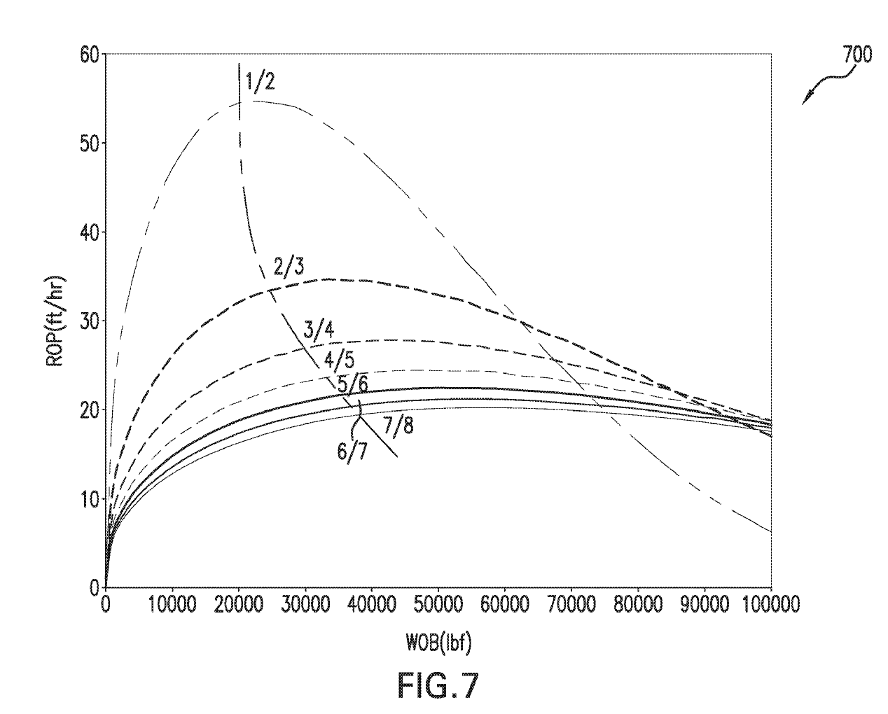

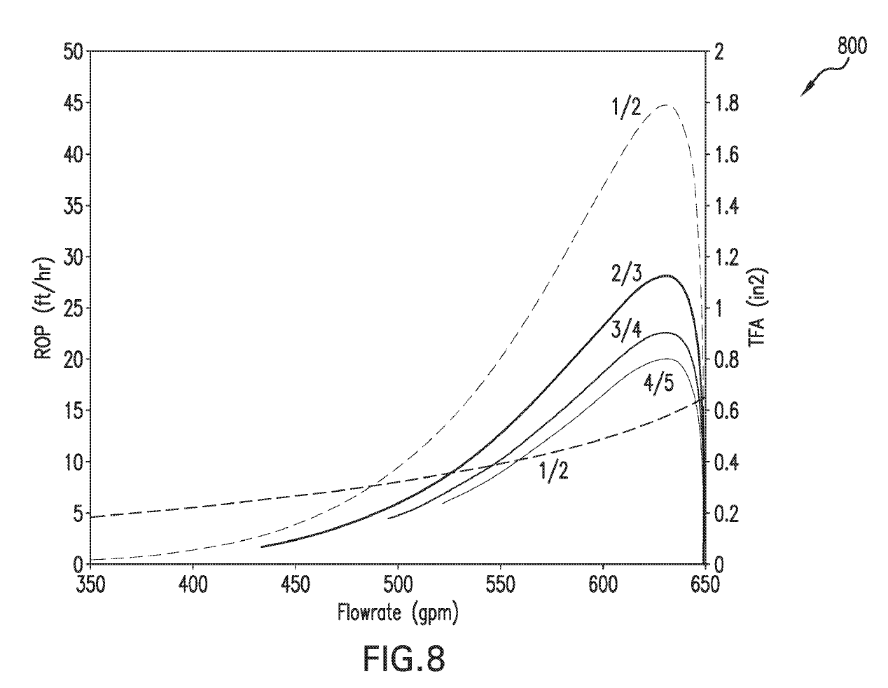

In addition to the graphical representations of the well path and operating variables described above with respect to FIGS. 5 and 6, other types of visualizations may be provided, such as those shown in FIGS. 7 and 8. In particular, FIG. 7 is a diagram of an illustrative plot graph 700 showing ROP parameter values relative to WOB for different stages of a drilling operation. FIG. 8 is a diagram of an illustrative plot graph 800 showing ROP parameter values relative to flow rate for different stages of a drilling operation.

In one or more embodiments, the above-described visualizations of FIGS. 5-8 may provide a drilling operator with an efficient way to monitor the drilling operation and adjust one or more drilling parameters as needed to control the value of the operating variable and/or the planned path of the well over different stages of the operation. However, it should be appreciated that the real-time data analysis and optimization techniques disclosed herein are not limited thereto and that the adjustment of the drilling parameters and/or well path may be automated and performed without any user intervention by a well planning and control system, e.g., the well planner 310 of FIG. 3, as described above.

Referring back to FIG. 3, the well planner 310 may be used to perform automated monitoring and control of the drilling operation. In one or more embodiments, the functions performed by the well planner 210 and its components, including data classifier 212, data analyzer 214, optimization controller 216, and data visualizer 218, as described above with respect to system 300 of FIG. 3 and process 400 of FIG. 4, may be implemented as part of a computer application for well engineering (e.g., well engineering application 280 of FIG. 2, as described above). For example, the well planner 310 may be implemented as a plug-in of such a well engineering application. The well engineering application may be executable at, for example, a computing device of a drilling operator for purposes of planning and optimizing a downhole operation at a well site. The computing device may be, for example, a surface computing device (e.g., surface computer system 240 of FIG. 2, as described above) located at the well site itself. Alternatively, the computing device may be a computing device (e.g., remote computer system 242 of FIG. 2, as described above) that is located away from the well site and that is configured to remotely monitor and control well site operations through communications with well site computing devices via a network (e.g., network 204 of FIG. 2, as described above).

In one or more embodiments, the automated monitoring and control functions performed by the well planner 310 may include using the optimization controller 316 to continuously monitor and compare the initial target value of the operating variable with the actual value of the operating variable calculated at various points (e.g., different depth intervals) along the planned well path over one or more stages of the drilling operation. The optimization controller 316 may automatically update the target value of the operating variable based on the comparison, e.g., if the optimization controller 316 detects a variation between the actual and target values that exceeds a predetermined tolerance threshold. As described above, the target value may be updated using any various techniques. The optimization controller 316 may also determine the difference between the values of the drilling parameters determined based on the initial target value of the operating variable and the values of the parameters that, if used, should cause the system to achieve the updated target value. The optimization controller 316 may then automatically adjust one or more drilling parameters without input from the human drilling operator.

In some implementations, the optimization controller 316 may implement one or more proportional-integral-differential (PID) control loops (e.g., one for each drilling parameter). Such PID control loops may continually adjust the drilling parameters in an attempt to have a current value of the operating variable match the updated target value. Additionally, the optimization controller 316 may suggest to the drilling operator a change in one or more drilling parameters, and leave making the actual changes to the judgment of the drilling operator.

As described above, the initial target value of the operating variable for the current well may be set to an actual value of the operating variable calculated for a nearby well that has already been drilled within a similar type of formation. In one or more embodiments, the actual value of the operating variable calculated for a point along the nearby well may instead be used to update the initial target value of the operating variable for the current well. For example, the data classifier 312 of the well planner 310 may access the database 350 via the network 304 to find information pertaining to nearby wells that are being drilled or have been drilled. In one or more embodiments, such information may be used to determine the proximity of nearby boreholes that have already drilled through the formation material which is or is about to be drilled by the current borehole. For example, the optimization controller 316 may use the indications of the drilling parameter values used during the drilling operation at the nearby well as a guide to setting the drilling parameters in the current well so as to achieve the updated target value.

In one or more embodiments, the data classier 312 may scan the database 350 and any other databases accessible via the network 304 to identify nearby wells based on predetermined criteria, e.g., a predetermined distance or geographic location of other wells relative to the current well. If a nearby well meets the distance or location criteria, the data classifier 312 may retrieve data regarding a corresponding depth, the values of the drilling parameters associated with a selected operating variable, and the actual values of the selected operating variable achieved with those parameter values. The optimization controller 316 may then use the actual value from the nearby well to update the target value of the operating variable to perform the drilling operation for the current well.

While the various embodiments are described herein in the context of surface computer systems, it should be noted that the disclosed data analysis and parameter optimization techniques are not intended to be limited thereto. In one or more embodiments, some or all of the calculations related to the operating variable and/or the drilling parameters may be performed by a processor within a downhole tool disposed within the wellbore proximate to the drill bit. For example, the telemetry module 124 of FIGS. 1 and 2, as described above, may include a computer system for performing such calculations downhole. The telemetry module 124 may include an encoding system, such as a mud pulser, for communicating (e.g., via telemetry) some or all the calculation results to the surface computer systems. In cases where control of the operational parameter is automated, the telemetry module 124 or other downhole computer system (e.g., a downhole geosteering tool) coupled thereto may be used automatically control or change one or more drilling parameters (e.g., speed of the mud motor 112 and other controllable parameters).

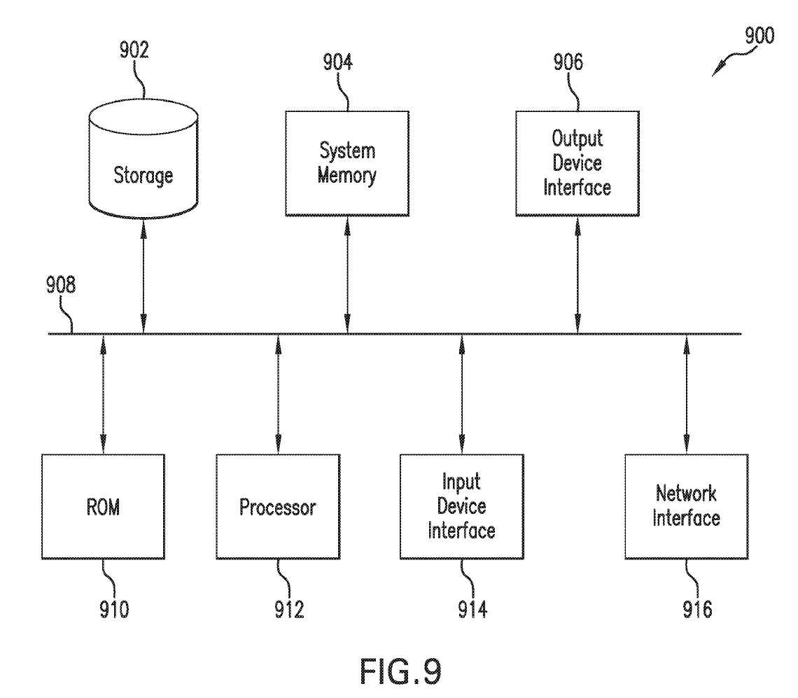

FIG. 9 is a block diagram of an exemplary computer system 900 in which embodiments of the present disclosure may be implemented. For example, process 400 of FIG. 4 and the functions performed by system 300 (including well planner 310) of FIG. 3, as described above, may be implemented using system 900. System 900 can be a computer, phone, PDA, or any other type of electronic device. Such an electronic device includes various types of computer readable media and interfaces for various other types of computer readable media. As shown in FIG. 9, system 900 includes a permanent storage device 902, a system memory 904, an output device interface 906, a system communications bus 908, a read-only memory (ROM) 910, processing unit(s) 912, an input device interface 914, and a network interface 916.

Bus 908 collectively represents all system, peripheral, and chipset buses that communicatively connect the numerous internal devices of system 900. For instance, bus 908 communicatively connects processing unit(s) 912 with ROM 910, system memory 904, and permanent storage device 902.

From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of system 900. Permanent storage device 902, on the other hand, is a read-and-write memory device. This device is a non-volatile memory unit that stores instructions and data even when system 900 is powered off. Some implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such a random access memory. System memory 904 stores some of the instructions and data that the processor needs at runtime. In some implementations, the processes of the subject disclosure are stored in system memory 904, permanent storage device 902, and/or ROM 910. For example, the various memory units include instructions for computer aided pipe string design based on existing string designs in accordance with some implementations. From these various memory units, processing unit(s) 912 retrieves instructions to execute and data to process in order to execute the processes of some implementations.

Bus 908 also connects to input and output device interfaces 914 and 906. Input device interface 914 enables the user to communicate information and select commands to the system 900. Input devices used with input device interface 914 include, for example, alphanumeric, QWERTY, or T9 keyboards, microphones, and pointing devices (also called “cursor control devices”). Output device interfaces 906 enables, for example, the display of images generated by the system 900. Output devices used with output device interface 906 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 9, bus 908 also couples system 900 to a public or private network (not shown) or combination of networks through a network interface 916. Such a network may include, for example, a local area network (“LAN”), such as an Intranet, or a wide area network (“WAN”), such as the Internet. Any or all components of system 900 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, process 400 of FIG. 4 and the functions performed by system 300 of FIG. 3, as described above, may be implemented using system 900 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for (1) real-time monitoring and optimization of drilling performance and (2) real-time prediction of failures/incidents (e.g., drill bit wear-out, stuck-pipe conditions, etc.). Accordingly, advantages of the present disclosure include (1) providing a straightforward visualization for real-time monitoring of wellsite operations and (2) real-time model training for improved optimization and prediction of drilling performance.

In one or more embodiments of the present disclosure, a computer-implemented method of optimizing parameters for drilling operations includes: receiving input from a user selecting an operating variable of interest for optimizing different stages of a drilling operation to be performed along a planned path of a well within a subsurface formation; estimating an initial target value of the selected operating variable for each stage of the drilling operation along the planned path of the well based on a first set of wellsite data associated with the planned path of the well; determining values of one or more drilling parameters for performing each stage of the drilling operation along a corresponding portion of the planned well path, based on the initial target value of the operating variable estimated for that stage; updating the initial target value of the operating variable based on a second set of wellsite data obtained during a current stage of the drilling operation performed along the planned well path; optimizing the values of the one or more drilling parameters for performing subsequent stages of the drilling operation based on the updated target value of the operating variable; adjusting the planned path of the well for subsequent stages of the drilling operation, based on the optimized values of the one or more drilling parameters; and performing the subsequent stages of the drilling operation along the adjusted path of the well.

Further, a computer-readable storage medium with instructions stored therein has been described, where the instructions when executed by a computer cause the computer to perform a plurality of functions, including functions to: receive input from a user selecting an operating variable of interest for optimizing different stages of a drilling operation to be performed along a planned path of a well within a subsurface formation; estimate a target value of the selected operating variable for each stage of the drilling operation along the planned path of the well based on a first set of wellsite data associated with the planned path of the well; determine values of one or more drilling parameters for performing each stage of the drilling operation along a corresponding portion of the planned well path, based on the estimated target value of the operating variable for that stage; update the target value of the operating variable based on a second set of wellsite data obtained during a current stage of the drilling operation performed along the planned well path; optimize the values of the one or more drilling parameters for performing subsequent stages of the drilling operation based on the updated target value of the operating variable; adjust the planned path of the well for subsequent stages of the drilling operation, based on the optimized values of the one or more drilling parameters; and perform the subsequent stages of the drilling operation along the adjusted path of the well.

For the foregoing embodiments, the first set of wellsite data may be historical wellsite data associated with one or more nearby wells, and the second set of wellsite data may be real-time data collected from the well during the current stage of the drilling operation. Further, such embodiments may further include any one of the following functions, operations or elements, alone or in combination with each other: determining an actual value of the operating variable for the current stage of the drilling operation, based on the second set of wellsite data obtained while the current stage is performed along a portion of the planned path of the well; updating the initial target value of the operating variable based on a difference between the actual value and the initial target value for the current stage; and providing a visualization of the initial target value, the actual target value, and the updated target value for the operating variable along the portion of the planned path of the well corresponding to the current stage of the drilling operation. The visualization may be displayed within a graphical user interface (GUI) of an application executable at the user's computing device. The visualization may include a three-dimensional (3D) representation of the planned path of the well superimposed on a 3D coordinate system. The 3D representation of the planned path of the well may include a 3D representation of boundary conditions for values of the operating variable during the current stage of the drilling operation. The one or more drilling parameters may be part of a set of drilling parameters used to control the values of the operating variable during the drilling operation, and the boundary conditions are based on predetermined values of the drilling parameters in the set.

In one or more embodiments, a system for optimizing parameters for drilling operations includes at least one processor and a memory coupled to the processor that has instructions stored therein, which when executed by the processor, cause the processor to perform functions, including functions to: receive input from a user selecting an operating variable of interest for optimizing different stages of a drilling operation to be performed along a planned path of a well within a subsurface formation; estimate a target value of the selected operating variable for each stage of the drilling operation along the planned path of the well based on a first set of wellsite data associated with the planned path of the well; determine values of one or more drilling parameters for performing each stage of the drilling operation along a corresponding portion of the planned well path, based on the estimated target value of the operating variable for that stage, update the target value of the operating variable based on a second set of wellsite data obtained during a current stage of the drilling operation performed along the planned well path; optimize the values of the one or more drilling parameters for performing subsequent stages of the drilling operation based on the updated target value of the operating variable; adjust the planned path of the well for subsequent stages of the drilling operation, based on the optimized values of the one or more drilling parameters; and perform the subsequent stages of the drilling operation along the adjusted path of the well.

In one or more embodiments of the foregoing system, the first set of wellsite data may be historical wellsite data associated with one or more nearby wells, and the second set of wellsite data may be real-time data collected from the well during the current stage of the drilling operation. Further, the functions performed by the processor for such embodiments may further include any one or combination of functions to: determine an actual value of the operating variable for the current stage of the drilling operation, based on the second set of wellsite data obtained while the current stage is performed along a portion of the planned path of the well; update the initial target value of the operating variable based on a difference between the actual value and the initial target value for the current stage; and provide a visualization of the initial target value, the actual target value, and the updated target value for the operating variable along the portion of the planned path of the well corresponding to the current stage of the drilling operation. The visualization may be displayed within a graphical user interface (GUI) of an application executable at the user's computing device. The visualization may include a three-dimensional (3D) representation of the planned path of the well superimposed on a 3D coordinate system. The 3D representation of the planned path of the well may include a 3D representation of boundary conditions for values of the operating variable during the current stage of the drilling operation. The one or more drilling parameters may be part of a set of drilling parameters used to control the values of the operating variable during the drilling operation, and the boundary conditions are based on predetermined values of the drilling parameters in the set.

While specific details about the above embodiments have been described, the above hardware and software descriptions are intended merely as example embodiments and are not intended to limit the structure or implementation of the disclosed embodiments. For instance, although many other internal components of the system 900 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A method of optimizing parameters for drilling operations, the method comprising:
receiving input from a user selecting an operating variable of interest for optimizing different stages of a drilling operation to be performed along a planned path of a well within a subsurface formation;
estimating an initial target value of the selected operating variable for each stage of the drilling operation along the planned path of the well based on a first set of wellsite data associated with the planned path of the well;
determining values of one or more drilling parameters for performing each stage of the drilling operation along a corresponding portion of the planned well path, based on the initial target value of the operating variable estimated for that stage;
updating the initial target value of the operating variable based on a second set of wellsite data obtained during a current stage of the drilling operation performed along the planned well path;
optimizing the values of the one or more drilling parameters for performing subsequent stages of the drilling operation based on the updated target value of the operating variable;
adjusting the planned path of the well for subsequent stages of the drilling operation, based on the optimized values of the one or more drilling parameters; and
performing the subsequent stages of the drilling operation along the adjusted path of the well.

2. The method of claim 1, wherein the first set of wellsite data is historical wellsite data associated with one or more nearby wells.

3. The method of claim 2, wherein the second set of wellsite data is real-time data collected from the well during the current stage of the drilling operation.

4. The method of claim 1, wherein updating comprises:
determining an actual value of the operating variable for the current stage of the drilling operation, based on the second set of wellsite data obtained while the current stage is performed along a portion of the planned path of the well; and
updating the initial target value of the operating variable based on a difference between the actual value and the initial target value for the current stage.

5. The method of claim 4, further comprising:
providing a visualization of the initial target value, the actual target value, and the updated target value for the operating variable along the portion of the planned path of the well corresponding to the current stage of the drilling operation.

6. The method of claim 5, wherein the visualization is displayed within a graphical user interface (GUI) of an application executable at the user's computing device.

7. The method of claim 5, wherein the visualization includes a three-dimensional (3D) representation of the planned path of the well superimposed on a 3D coordinate system.

8. The method of claim 7, wherein the 3D representation of the planned path of the well includes a 3D representation of boundary conditions for values of the operating variable during the current stage of the drilling operation.

9. The method of claim 8, wherein the one or more drilling parameters are part of a set of drilling parameters used to control the values of the operating variable during the drilling operation, and the boundary conditions are based on predetermined values of the drilling parameters in the set.

10. A system for optimizing parameters for drilling operations, the system comprising:
at least one processor; and
a memory coupled to the processor having instructions stored therein, which when executed by the processor, cause the processor to perform functions including functions to:
receive input from a user selecting an operating variable of interest for optimizing different stages of a drilling operation to be performed along a planned path of a well within a subsurface formation;
estimate a target value of the selected operating variable for each stage of the drilling operation along the planned path of the well based on a first set of wellsite data associated with the planned path of the well;
determine values of one or more drilling parameters for performing each stage of the drilling operation along a corresponding portion of the planned well path, based on the estimated target value of the operating variable for that stage;
update the target value of the operating variable based on a second set of wellsite data obtained during a current stage of the drilling operation performed along the planned well path;
optimize the values of the one or more drilling parameters for performing subsequent stages of the drilling operation based on the updated target value of the operating variable;
adjust the planned path of the well for subsequent stages of the drilling operation, based on the optimized values of the one or more drilling parameters; and
perform the subsequent stages of the drilling operation along the adjusted path of the well.

11. The system of claim 10, wherein the first set of wellsite data is historical wellsite data associated with one or more nearby wells.

12. The system of claim 11, wherein the second set of wellsite data is real-time data collected from the well during the current stage of the drilling operation.

13. The system of claim 10, wherein the functions performed by the processor further include functions to:
determine an actual value of the operating variable for the current stage of the drilling operation, based on the second set of wellsite data obtained while the current stage is performed along a portion of the planned path of the well; and
update the initial target value of the operating variable based on a difference between the actual value and the initial target value for the current stage.

14. The system of claim 13, wherein the functions performed by the processor further include functions to:
provide a visualization of the initial target value, the actual target value, and the updated target value for the operating variable along the portion of the planned path of the well corresponding to the current stage of the drilling operation.

15. The system of claim 14, wherein the visualization is displayed within a graphical user interface (GUI) of an application executable at the user's computing device.

16. The system of claim 14, wherein the visualization includes a three-dimensional (3D) representation of the planned path of the well superimposed on a 3D coordinate system.

17. The system of claim 16, wherein the 3D representation of the planned path of the well includes a 3D representation of boundary conditions for values of the operating variable during the current stage of the drilling operation.

18. The system of claim 17, wherein the one or more drilling parameters are part of a set of drilling parameters used to control the values of the operating variable during the drilling operation, and the boundary conditions are based on predetermined values of the drilling parameters in the set.

19. A computer-readable storage medium having instructions stored therein, which when executed by a computer cause the computer to perform a plurality of functions, including functions to:
receive input from a user selecting an operating variable of interest for optimizing different stages of a drilling operation to be performed along a planned path of a well within a subsurface formation;
estimate a target value of the selected operating variable for each stage of the drilling operation along the planned path of the well based on a first set of wellsite data associated with the planned path of the well;
determine values of one or more drilling parameters for performing each stage of the drilling operation along a corresponding portion of the planned well path, based on the estimated target value of the operating variable for that stage;
update the target value of the operating variable based on a second set of wellsite data obtained during a current stage of the drilling operation performed along the planned well path;
optimize the values of the one or more drilling parameters for performing subsequent stages of the drilling operation based on the updated target value of the operating variable;
adjust the planned path of the well for subsequent stages of the drilling operation, based on the optimized values of the one or more drilling parameters; and
perform the subsequent stages of the drilling operation along the adjusted path of the well.

20. The computer-readable storage medium of claim 19, wherein the first set of wellsite data is historical wellsite data associated with one or more nearby wells, and the second set of wellsite data is real-time data collected from the well during the current stage of the drilling operation.
